(19) United States
(12) Patent Application Publication
(10) Pub. No.: US 2025/0390347 A1
(43) Pub. Date: Dec. 25, 2025

(54) SYSTEM, METHOD, AND COMPUTER PROGRAM FOR OPTIMIZATION OF ALLOCATION OF COMPUTE JOB RESOURCES IN A MULTI-CLOUD ENVIRONMENT

(71) Applicant: Amdocs Development Limited, Limassol (CY)

(72) Inventors: Pavel Yefim May, Rishon leZion (IL); Adi Lachman, Tel Mond (IL)

(21) Appl. No.: 18/749,430

(22) Filed: Jun. 20, 2024

(51) Int. Cl. G06F 9/50

(52) U.S. Cl. CPC G06F 9/5027

(57) ABSTRACT

As described herein, a system, method, and computer program are provided for optimization of allocation of compute job resources in a multi-cloud environment. A compute job to be run is identified. An optimization target for the compute job is determined. Resource requirements of the compute job and resource availability for a plurality of cloud networks are processed to determine a resource allocation across the plurality of cloud networks that satisfies the optimization target for the compute job. The resource allocation is orchestrated for the compute job.

### FIELD OF THE INVENTION

The present invention relates to allocating network resources to compute jobs.

### BACKGROUND

Optimizing compute jobs in a multi-cloud environment requires allocating the right cloud resource for each part of the job. Jobs can be optimized in multiple dimensions, such as minimizing financial costs, maximizing performance, minimizing resources used, and so on. Sometimes, different resources of a job need to be optimized for different dimensions.

Existing solutions today know how to assess the different costs for different types of jobs on different cloud environments. However, the solutions apply to all job resources, and usually measure a single dimension on a single cloud environment.

There is thus a need for addressing these and/or other issues associated with the prior art. For example, there is a need to determine in an ad-hoc manner how to optimize resource allocations for a compute job over multiple cloud environments by a select optimization dimension.

### SUMMARY

As described herein, a system, method, and computer program are provided for optimization of allocation of compute job resources in a multi-cloud environment. A compute job to be run is identified. An optimization target for the compute job is determined. Resource requirements of the compute job and resource availability for a plurality of cloud networks are processed to determine a resource allocation across the plurality of cloud networks that satisfies the optimization target for the compute job. The resource allocation is orchestrated for the compute job.

### BRIEF DESCRIPTION OF THE DRAWINGS

FIG. 1 illustrates a method for optimization of allocation of compute job resources in a multi-cloud environment, in accordance with one embodiment.

FIG. 2 illustrates a communication flow among components of a system for optimization of allocation of compute job resources in a multi-cloud environment, in accordance with one embodiment.

FIG. 3 illustrates a system for fulfilling a compute job, in accordance with one embodiment.

FIG. 4 illustrates an exemplary flow carried out using the system of FIG. 3, in accordance with one embodiment.

FIG. 5 illustrates a network architecture, in accordance with one possible embodiment.

FIG. 6 illustrates an exemplary system, in accordance with one embodiment.

### DETAILED DESCRIPTION

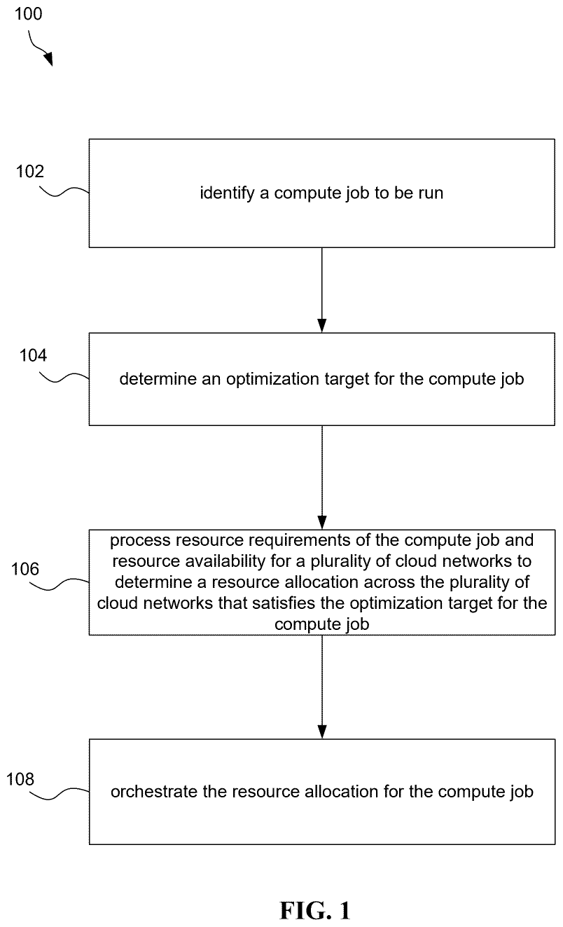

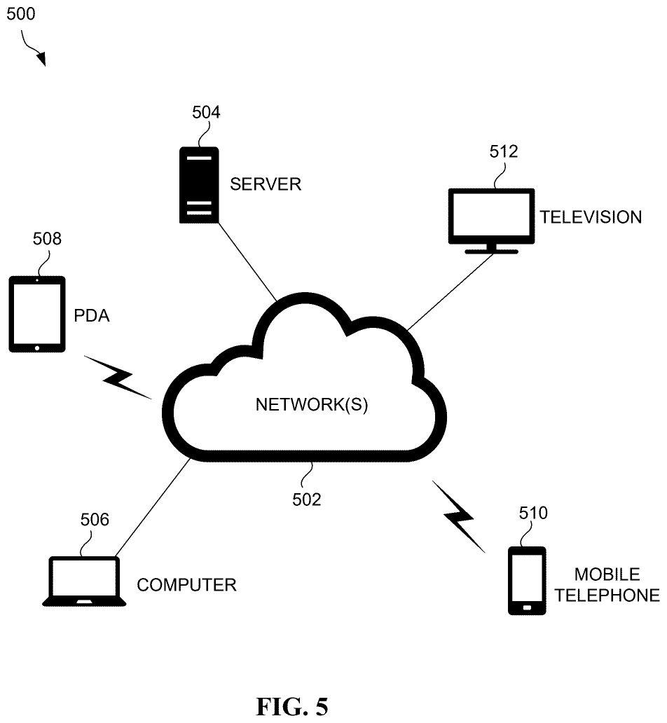

FIG. 1 illustrates a method 100 for optimization of allocation of compute job resources in a multi-cloud environment, in accordance with one embodiment. The method may be carried out by a computer system, such as that described below with respect to FIGS. 5 and/or 6.

In operation 102, a compute job to be run is identified. The compute job refers to any unit of work or unit of execution to be run (e.g. executed) using computing resources. In embodiments, the compute job may include a task or a group of tasks. In embodiments, the compute job may be associated with a software application or a computing service.

The compute job may be identified in any desired manner. In an embodiment, the compute job may be identified in response to a request to run the compute job. The request may be issued by the application, service, or device requiring that the compute job be run.

In operation 104, an optimization target for the compute job is determined. The optimization target refers to a dimension of the compute job that is to be optimized. In an embodiment, the optimization target may be selected for the compute job from among a plurality of possible optimization targets. In embodiments, the optimization target may be to optimize a cost of the compute job, a performance of the compute job, etc. In an embodiment, the optimization target may be specified with the request to run the compute job.

In operation 106, resource requirements of the compute job and resource availability for a plurality of cloud networks are processed to determine a resource allocation across the plurality of cloud networks that satisfies the optimization target for the compute job. The resource requirements of the compute job refer to resources required for the compute job to run. In an embodiment, the resource requirements may include cloud resources required to run the compute job, such as file storage, databases, computing clusters, or other hardware and/or software resources. The resource requirements may be specified in metadata for the compute job.

Each of the cloud networks refer to virtual network components, topologies, and configurations that run on a provider's physical networking infrastructure which includes various hardware and software resources. In an embodiment, the plurality of cloud networks may include cloud networks of different cloud network providers. In an embodiment, the plurality of cloud networks include two or more different types of cloud networks, such as a public cloud, a private cloud, and/or a hybrid cloud.

The resource availability for the plurality of cloud networks may refer to available (e.g. free, not allocated, etc.) resources of each of the cloud networks. In an embodiment, the resource availability may be determined based on current resource availability information provided (e.g. published, etc.) by each of the cloud networks. The current resource availability information may indicate resources not currently allocated to other compute jobs.

As mentioned, the resource requirements of the compute job and the resource availability for the plurality of cloud networks are processed to determine a resource allocation across the plurality of cloud networks that satisfies the optimization target for the compute job. The resource allocation refers to an allocation (e.g. assignment) of cloud network resources to the compute job.

In an embodiment, the processing may include, for each of the resource requirements of the compute job, evaluating each cloud network of the plurality of cloud networks based on the optimization target. For example, when the optimization target is to optimize a cost of the compute job, then each of the cloud networks may be evaluated to determine a cost for allocating each of the required resources of the compute job. As another example, when the optimization target is to optimize a performance of the compute job, then each of the cloud networks may be evaluated to determine a performance that will be provided by its resources for each of the required resources of the compute job.

It should be noted that the evaluation may be performed using a predefined evaluation function. The processing may further include, for each of the resource requirements of the compute job, selecting one cloud network of the plurality of cloud networks with a best evaluation result. For example, a cloud network with a lowest cost or best performance may be selected for each of the resource requirements of the compute job. To this end, the resource allocation may include allocation of a resource in a selected cloud network to satisfy a respective resource requirement.

In an embodiment, the resource allocation may include allocation of resources in different cloud networks of the plurality of cloud networks for at least a subset of the resource requirements of the compute job. In another embodiment, the resource allocation may include allocation of resources in a same cloud network of the plurality of cloud networks for at least a subset of the resource requirements of the compute job.

In operation 108, the resource allocation is orchestrated for the compute job. In an embodiment, orchestrating the resource allocation for the compute job may include creating resources across the plurality of cloud networks for the compute job. In another embodiment, orchestrating the resource allocation for the compute job may include assigning resources across the plurality of cloud networks for the compute job. Further, the method 100 may include causing the compute job to run using the resource allocation orchestrated for the compute job.

To this end, the method 100 may be carried out to provide optimization of allocation of compute job resources in a multi-cloud environment. This method 100 may allow ad-hoc decisions to be made regarding how to optimize each resource of a compute job by the appropriate optimization dimension and across multiple cloud environments. In particular, the method 100 may allow for an optimal distribution of available resources from a multi-cloud environment in an ad-hoc manner, which for example can be used reducing cost for running compute jobs with multiple resources of different types where cost-effective management cannot be a trivial and manually handled task.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

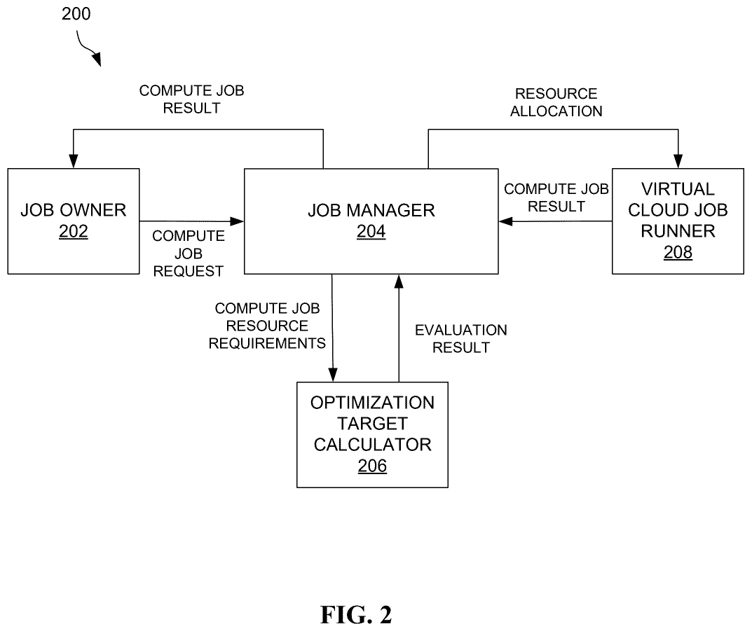

FIG. 2 illustrates a communication flow among components of a system 200 for optimization of allocation of compute job resources in a multi-cloud environment, in accordance with one embodiment. As an option, the system 200 may be implemented in the context of the details of the previous figure and/or any subsequent figure(s). Of course, however, the system 200 may be implemented in the context of any desired environment. Further, the aforementioned definitions may equally apply to the description below.

The system 200 includes a job owner 202 which refers to an application, service, or device that has a compute job to be run. The job owner 202 sends a request to run the compute job to a job manager 204. The job manager 204 refers to a service or application that determines resource allocations across a plurality of cloud networks for the requested compute job. While only a single job owner 202 is illustrated, it should be noted that any number of different job owners may similarly communicate with the job manager 204 for compute job resource allocation purposes. In an embodiment, the job manager 204 may be a software-as-a-service (SaaS)-based application operating as a front-end for running compute jobs.

The job manager 204 communicates resource requirements of the compute job to an optimization target calculator 206 which is a function or service configured to process the resource requirements of the compute job as well as resource availability of the cloud networks to evaluate the cloud networks for each required resource of the compute job in terms of an optimization target defined for the compute job. It should be noted that different compute jobs may have different optimization targets defined therefor.

The optimization target calculator 206 returns an evaluation result to the job manager 204. The evaluation result indicates a select (e.g. best) cloud resource to provide each required resource of the compute job, per the defined optimization target. While the optimization target calculator 206 is shown as separate from the job manager 204, other embodiments are considered in which the optimization target calculator 206 is a component of the job manager 204.

The job manager 204 then determines a resource allocation across the cloud networks in accordance with the evaluation result. The job manager 204 communicates the resource allocation to a virtual cloud job runner 208 which orchestrates allocation of resources in the cloud networks to the compute job, in accordance with the resource allocation communicated from the job manager 204. The virtual cloud job runner 208 may be an application or service.

Once the compute job completes running, a result of the compute job is communicated from the virtual cloud job runner 208 to the job manager 204, which in turn communicates the result back to the job owner 202. In this way, the system 200 may operation such that each of multiple resources of a specific compute job are allocated in the currently available and the most cost-effective cloud deliberately selected between all currently available clouds.

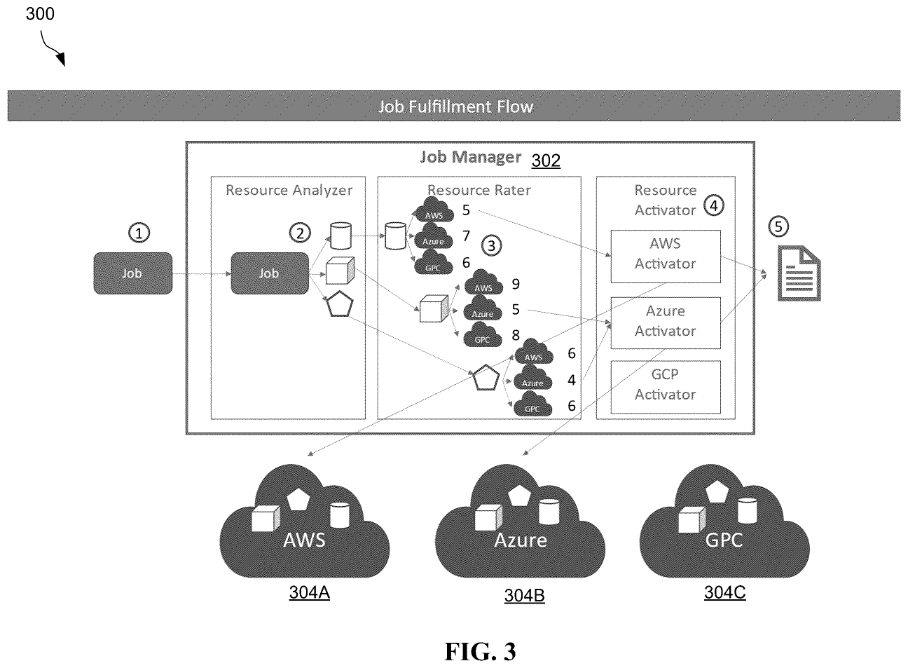

FIG. 3 illustrates a system 300 for fulfilling a compute job, in accordance with one embodiment. As an option, the system 300 may be implemented in the context of the details of the previous figure and/or any subsequent figure(s). Of course, however, the system 300 may be implemented in the context of any desired environment. Further, the aforementioned definitions may equally apply to the description below.

In step (1) a compute job is sent to a job manager 302. In (2), a resource analyzer of the job manager 302 determines resource requirements of the compute job. In (3), a resource rater of the job manager 302 (or the optimization target calculator 206 from FIG. 2) processes the resource requirements of the compute job as well as resource availability of the cloud networks 304A-C to evaluate the cloud networks for each required resource of the compute job in terms of an optimization target defined for the compute job.

In (4), a resource activator of the job manager 302 allocates resources in the cloud networks 304A-C to satisfy the resource requirements of the compute job, based on the evaluation result from the resource rater. In (5), a result of the compute job run is output.

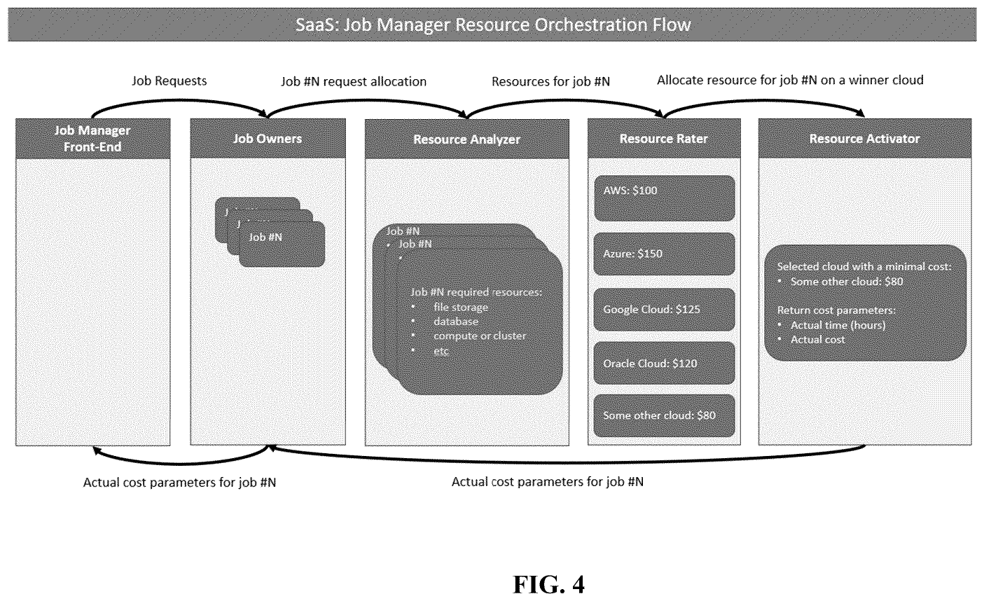

FIG. 4 illustrates an exemplary flow carried out using the system 300 of FIG. 3, in accordance with one embodiment.

In the example shown, a job request received through a job manager 302 front-end causes job owners to be consulted about resource requirements for the compute job being requested. The resource analyzer determines the resource requirements for the compute job, such as file storage, database, compute, cluster, etc. requirements. The resource rater processes the resource requirements of the compute job as well as resource availability of the cloud networks 304A-C to evaluate the cloud networks for each required resource of the compute job in terms of an optimization target defined for the compute job. In the example shown, the optimization target is cost-related. The resource activator allocates resources in the cloud networks to satisfy the resource requirements of the compute job, based on the evaluation result from the resource rater. In the example shown, cloud networks with a lowest cost per resource are selected for the resource allocation. A result of the compute job run is returned by the resource activator to the job owners and the job manager 302 front-end, including an actual cost of running the compute job on the selected cloud networks.

FIG. 5 illustrates a network architecture 500, in accordance with one possible embodiment. As shown, at least one network 502 is provided. In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 504 and an end user computer 506 may be coupled to the network 502 for communication purposes. Such end user computer 506 may include a desktop computer, lap-top computer, and/or any other type of logic. Still yet, various other devices may be coupled to the network 502 including a personal digital assistant (PDA) device 508, a mobile phone device 510, a television 512, etc.

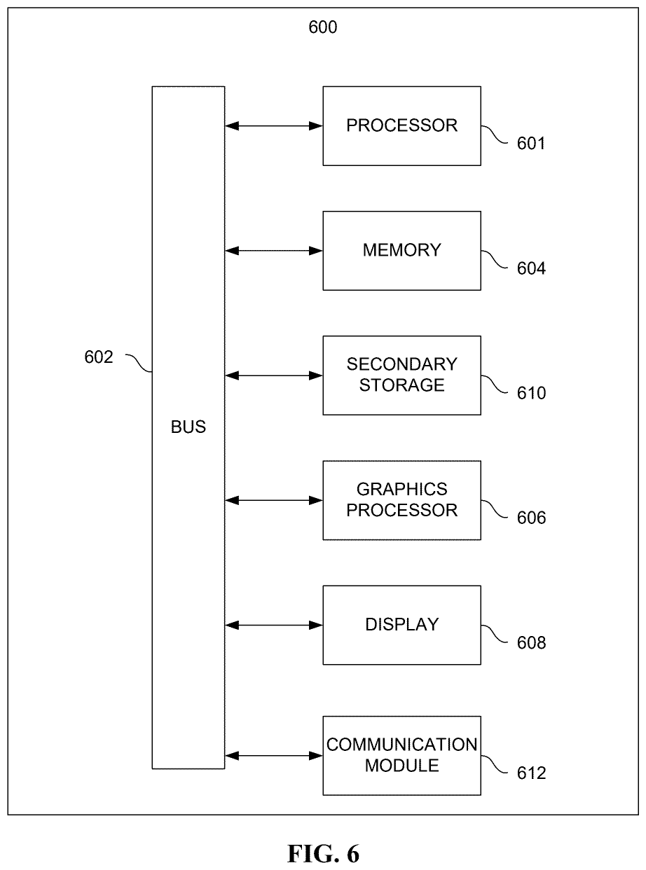

FIG. 6 illustrates an exemplary system 600, in accordance with one

embodiment. As an option, the system 600 may be implemented in the context of any of the devices of the network architecture 500 of FIG. 5. Of course, the system 600 may be implemented in any desired environment.

As shown, a system 600 is provided including at least one central processor 601 which is connected to a communication bus 602. The system 600 also includes main memory 604 [e.g. random access memory (RAM), etc.]. The system 600 also includes a graphics processor 606 and a display 608.

The system 600 may also include a secondary storage 610. The secondary storage 610 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 604, the secondary storage 610, and/or any other memory, for that matter. Such computer programs, when executed, enable the system 600 to perform various functions (as set forth above, for example). Memory 604, storage 610 and/or any other storage are possible examples of non-transitory computer-readable media.

The system 600 may also include one or more communication modules 612. The communication module 612 may be operable to facilitate communication between the system 600 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
identify a compute job to be run;
determine an optimization target for the compute job;
process resource requirements of the compute job and resource availability for a plurality of cloud networks to determine a resource allocation across the plurality of cloud networks that satisfies the optimization target for the compute job; and
orchestrate the resource allocation for the compute job.

2. The non-transitory computer-readable media of claim 1, wherein the compute job is identified in response to a request to run the compute job.

3. The non-transitory computer-readable media of claim 1, wherein the optimization target is selected for the compute job from among a plurality of possible optimization targets.

4. The non-transitory computer-readable media of claim 1, wherein the optimization target is to optimize a cost of the compute job.

5. The non-transitory computer-readable media of claim 1, wherein the optimization target is to optimize a performance of the compute job.

6. The non-transitory computer-readable media of claim 1, wherein the optimization target is specified with a request to run the compute job.

7. The non-transitory computer-readable media of claim 1, wherein the resource requirements include cloud resources required to run the compute job.

8. The non-transitory computer-readable media of claim 1, wherein the plurality of cloud networks include cloud networks of different cloud network providers.

9. The non-transitory computer-readable media of claim 1, wherein the plurality of cloud networks include two or more different types of cloud networks.

10. The non-transitory computer-readable media of claim 9, wherein the two or more different types of cloud networks are selected from:
a public cloud,
a private cloud, and
a hybrid cloud.

11. The non-transitory computer-readable media of claim 1, wherein processing the resource requirements of the compute job and the resource availability for the plurality of cloud networks to determine the resource allocation across the plurality of cloud networks that satisfies the optimization target for the compute job includes:
for each of the resource requirements of the compute job, evaluating each cloud network of the plurality of cloud networks based on the optimization target.

12. The non-transitory computer-readable media of claim 11, wherein processing the resource requirements of the compute job and the resource availability for the plurality of cloud networks to determine the resource allocation across the plurality of cloud networks that satisfies the optimization target for the compute job further includes:
for each of the resource requirements of the compute job, selecting one cloud network of the plurality of cloud networks with a best evaluation result.

13. The non-transitory computer-readable media of claim 12, wherein the resource allocation includes allocation of a resource in the selected cloud network to satisfy the resource requirement.

14. The non-transitory computer-readable media of claim 1, wherein the resource allocation includes allocation of resources in different cloud networks of the plurality of cloud networks for at least a subset of the resource requirements of the compute job.

15. The non-transitory computer-readable media of claim 1, wherein the resource allocation includes allocation of resources in a same cloud network of the plurality of cloud networks for at least a subset of the resource requirements of the compute job.

16. The non-transitory computer-readable media of claim 1, wherein orchestrating the resource allocation for the compute job includes creating resources across the plurality of cloud networks for the compute job.

17. The non-transitory computer-readable media of claim 1, wherein orchestrating the resource allocation for the compute job includes assigning resources across the plurality of cloud networks for the compute job.

18. The non-transitory computer-readable media of claim 1, wherein the device is further caused to:
cause the compute job to run using the resource allocation orchestrated for the compute job.

19. A method, comprising:
at a computer system:
identifying a compute job to be run;
determining an optimization target for the compute job;
processing resource requirements of the compute job and resource availability for a plurality of cloud networks to determine a resource allocation across the plurality of cloud networks that satisfies the optimization target for the compute job; and
orchestrating the resource allocation for the compute job.

20. A system, comprising:
a non-transitory memory storing instructions; and
one or more processors in communication with the non-transitory memory that execute the instructions to:
identify a compute job to be run;
determine an optimization target for the compute job;
process resource requirements of the compute job and resource availability for a plurality of cloud networks to determine a resource allocation across the plurality of cloud networks that satisfies the optimization target for the compute job; and
orchestrate the resource allocation for the compute job.
